(19) United States
(12) Patent Application Publication
(10) Pub. No.: US 2004/0250576 A1
(43) Pub. Date: Dec. 16, 2004

(54) Double-secured latch

(76) Inventor: Emory H. Flanders JR., Orlando, FL (US)

Correspondence Address: Terry M. Sanks, Esquire, Beusse, Brownlee, Bowdoin & Wolter, P.A., Suite 2500, 390 North Orange Avenue, Orlando, FL, 32801, US

(21) Appl. No.: 10/462,139

(22) Filed: Jun. 16, 2003

(51) Int. Cl. E05B 73/00; F16B 41/00

(52) U.S. Cl. 70/14; 70/230

(57) ABSTRACT

A latch assembly for securing to devices together, the latch assembly comprising a stem with a fixed connection element at a first end and a detachable connection element at a second end, a first connector attached to a first of the devices to hold the fixed connection element of the stem, a second connector attached to a second of the devices from which the detachable connection element is connected and disconnected from, a first securing device connected to the stem operable to prevent the detachable connection element from being removed from the second connector, and a second securing device preventing the first securing device from releasing the detachable connection.

### BACKGROUND OF THE INVENTION

This invention relates to a fastener, and more specifically, to a fastener that has a securing, or locking device that is also secured and/or locked.

Latches, or fasteners, used for securing and/or holding together gates, screen doors and/or adjoining panels, are well known in the prior art. A typical latch has a stem, rod, or shank, in which one end has an element to connect the latch to one object, such as a fence, and a second end that is operatable to be connected to and removed from a second object, such as a gate. Many of the prior art latches do not utilize a component to lock or hold the latch in place as it is engaged to hold two objects. In the prior art in which a securing or locking device is included, once the securing device is removed, then the latch is freely unlatched. In other embodiments, the locking device is a mechanical element with a plurality of mechanical components.

There has been minimal development with providing a locking system for a latch where the shank includes a double locking system. With respect to the development that has occurred, such systems are configured so that locking systems work in series as oppose to working in parallel. In other words in prior art, the second locking system only provides protection after the first locking system has been defeated. Though there may be some uses for such a system, gates manufacturers would benefit from an assembly in which both locking systems work together, or where the latch assembly is locked in place until the first locking system is released. Such an assembly will result in less wear and tear on the moveable parts of the latching assembly that result from non-authorized users moving elements of the latching assembly in an attempt to defeat one or both of the locking systems.

### BRIEF DESCRIPTION OF THE INVENTION

This invention is directed to a latch assembly which utilizes a double securing system to prevent a latch from being disengaged wherein the double securing system also prohibits an unauthorized user from moving parts of the latching assembly in an effort to defeat the latch assembly. Towards this end, a latch assembly for securing two devices together is disclosed. The latch assembly comprises a stem with a fixed connection element at a first end and a detachable connection element at a second end. A first connector attached to a first of the devices to hold the fixed connection element of the stem is also provided. A second connector is provided that is attached to a second of the devices from which the detachable connection element is connected and disconnected from. A first securing device is connected to the stem and is operable to prevent the detachable connection element from being removed from the second connector. A second securing device is provided preventing the first securing device from releasing the detachable connection.

In another preferred embodiment, a latch assembly for connecting two devices together is disclosed. This latch assembly comprises a rod with a screw eye at one end and a hook at a second end. A first connector is provided which holds the screw eye to a first of the two devices. A second connector through which the hook engages and disengages the second connector is also provided wherein the second connector is connected to a second of the two devices. A spring-loaded sleeve is connected to the rod and prevents the hook from disengaging the second connector. A securing device holding the spring-loaded sleeve in place and preventing the hook from being disengaged from the second connector is also provided.

In another embodiment, an improvement to a latch assembly having shank with a first end connected to a first object and a second end detachable from a second object is disclosed, The improvement comprises a first securing device connected to the shank and operable to hold the second end to the second object and a second securing device to hold the first securing device to the second object.

### BRIEF DESCRIPTION OF THE DRAWINGS

The features and advantages of the present invention will become apparent from the following detailed description of the invention when read with the accompanying drawings in which:

FIG. 1 is an exemplary embodiment of a latch assembly using a padlock;

FIG. 2 is an exemplary embodiment of the latch assembly using a pin; and

FIG. 3 is an exemplary embodiment of the latch assembly with the padlock removed and spring-loaded sleeve depressed.

### DETAILED DESCRIPTION OF THE INVENTION

With reference to the figures, exemplary embodiments of the invention will now be described. The scope of the invention disclosed is applicable to a plurality of latches, or closure devices. Thus, even though this invention is disclosed with respect to gate and door latches, one skilled in the art will recognize a plurality of other uses where a latch assembly with minimum movable mechanical parts where a double secured system is available would be a desired latch assembly.

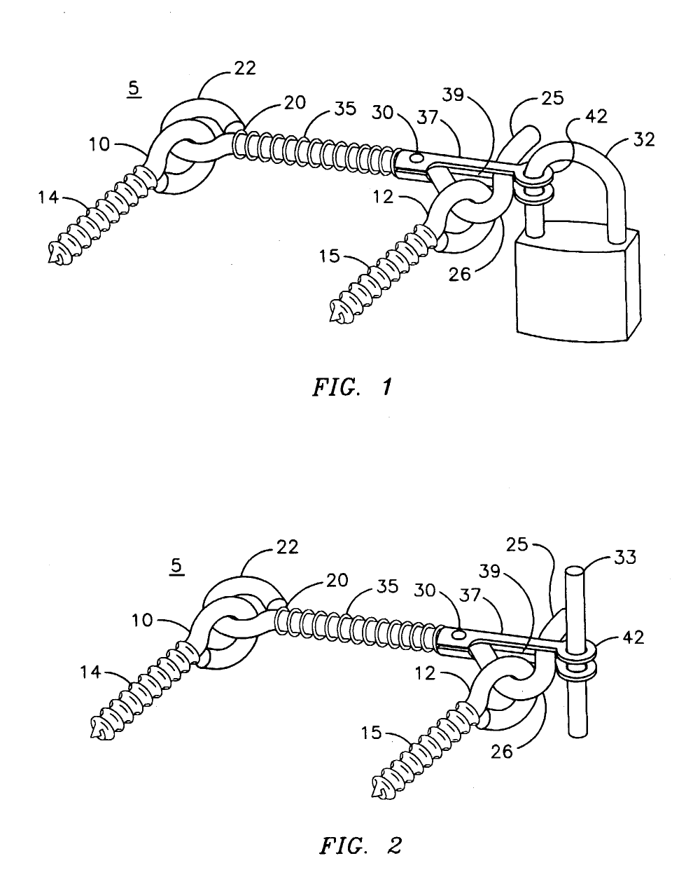

FIG. 1 is an exemplary embodiment of the latch assembly using a padlock, and FIG. 2 is an exemplary embodiment of the latch assembly using a pin. As illustrated, two connectors 10, 12 are provided which connect the latch assembly 5 to two objects (not illustrated), such as a gate and a door. In a preferred embodiment, the connectors 10, 12 are screw eye connectors where the connectors 10, 12 have a shank or stem 14, 15 which can be screwed into the objects that they will be connected to. In another preferred embodiment, not shown, the connectors 10, 12 can have a plurality of embodiments, including, but not limited to, adhesive-based connectors.

The latch assembly 5 also has a stem, rod, or shank, element 20 where one end of the stem 22 is configured to be connected to one of the connectors. This end is configured to always remain connected to the connector 10 and hence the object that the connector 10 is connected to. As illustrated in FIGS. 1 and 2, this end of the stem has an eye connector 22. The other end 25 of the stem 20 has a connection which can be connected to and removed from the second connector 12. As illustrated, a preferred configuration is for the second end of the stem 20 to have a hook configuration 6. One skilled in the art will readily recognize that other configurations for this end 25 of the stem 20 can be used.

Two security or securing devices 30, 32, 33 are provided where when connected together, all moving mechanical parts are held in place. The first securing device 30, in a preferred embodiment, is a spring-loaded sleeve that surrounds the stem 20. Though illustrated as being spring-loaded, one skilled in the art will recognize that other embodiments may be used, including providing a freely movable sleeve with a connection latch that holds it in place (not illustrated). As illustrated, the stem 20 fits within the interior of a spring 35. The spring 35 is connected to an attachment element 37 that is configured with an opening 39 allowing the hook 26 to fit within the element 37. The attachment element 37 includes an element 42, which prevents the hook 39 from being released from the connector 12. The attachment element 37 also has a receiving end 42 for a second securing device 32, 33, such as, but not limited to, a padlock 32, or a pin 31, to connect to it. Though illustrated as a separate element that can be completely disconnected, or removed, from the latch assembly 5, in other embodiments, the second securing device 32, 33 can be permanently connected to the latch assembly 5, such as, but not limited to, a locking pin 33 connected by a cord or small chain (not illustrated). When the second securing device 32, 33 is connected, the first securing device 30 is held in place.

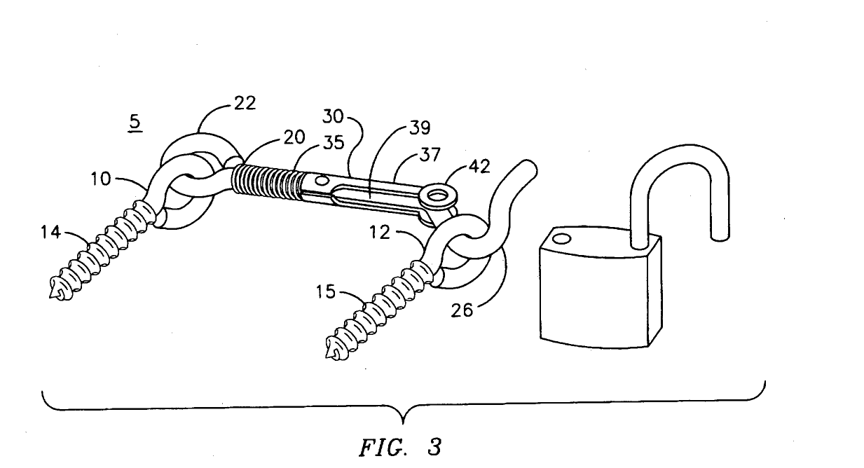

Thus, when the second securing device 32, 33 is removed from the receiving end 42 of the attachment element 37, as illustrated in FIG. 3, a user can push, or slide the attachment element 37 towards the spring 35, which depresses the spring 35. Doing so frees the hook 26, allowing the hook 26 to be removed from the connector 12.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

I claim as my invention:

1. A latch assembly for securing two devices together, said latch assembly comprising:
(a) a stem with a fixed connection element at a first end and a detachable connection element at a second end;
(b) a first connector attached to a first of said devices and to said fixed connection element of said stem;
(c) a second connector attached to a second of said devices from which said detachable connection element is connected and disconnected from;
(d) a first securing device connected to said stem operable to prevent said detachable connection element from being removed from said second connector; and
(e) a second securing device preventing said first securing device from releasing said detachable connection.

2. The latch assembly of claim 1 wherein said first securing device comprises a spring-loaded connector wherein said spring is depressed to release said first securing device from said second connector.

3. The latch assembly of claim 1 wherein said second securing device is a locking pin.

4. The latch assembly of claim 1 wherein said second securing device is a padlock.

5. The latch assembly claim 1 wherein said spring-loaded sleeve comprises a connector end through which said securing device fits.

6. A latch assembly for connecting two devices together, said latch assembly comprising:
(a) a rod with a screw eye at one end and a hook at a second end;
(b) a first connector holding said screw eye to a first of said two devices;
(c) a second connector through which said hook engages and disengages said second connector wherein said second connector is connected to a second of said two devices;
(d) a spring-loaded sleeve connected to said rod and preventing said hook from disengaging said second connector; and
(e) a securing device holding said spring-loaded sleeve in place and preventing said hook from being disengaged from said second connector.

7. The latch assembly claim 6 wherein said spring-loaded sleeve comprises a connector end through which said securing device fits.

8. The latch assembly of claim 6 wherein said spring-loaded sleeve requires a spring to be depressed to release said hook from said second connector.

9. The latch assembly of claim 6 wherein said securing device is a padlock.

10. The latch assembly of claim 6 wherein said securing device is a locking pin.

11. An improvement to a latch assembly having shank with a first end connected to a first object and a second end detachable from a second object, said improvement comprising:
(a) a first securing device connected to said shank and operable to hold said second end to said second object; and
(b) a second securing device to hold said first securing device to said second object.

12. The improvement of claims 11 wherein said first securing device is spring-loaded wherein said spring must be depressed before releasing said second end from said second object.

13. The improvement of claim 11 wherein said first securing device further comprises a receiver end to accept said second securing device.

14. The improvement of claim 11 wherein said second securing device is a padlock.

15. The improvement of claim 11 wherein said second securing device is a pin.
